(19) United States
(12) Patent Application Publication
(10) Pub. No.: US 2013/0199437 A1
(43) Pub. Date: Aug. 8, 2013

(54) BOOKTAG

(71) Applicant: GARY JOHNSON, Spring, TX (US)

(72) Inventor: GARY JOHNSON, Spring, TX (US)

(21) Appl. No.: 13/366,239

(22) Filed: Feb. 3, 2012

(51) Int. Cl. B42D 9/00

(52) U.S. Cl. 116/234

(57) ABSTRACT

The BOOKTAG is a simple one-sheet specific page location device that indicates the page intended within a book irrespective of which way it is turned within the book or which face is viewed. It is printed on two faces in such a way as to allow a change of indication to the opposite page by inverting the device top to bottom.

### 6. BACKGROUND OF THE INVENTION

The prior art of page-defining bookmarks falls into two categories: (A) hanging paper, plastic or metal sheets and (B) pre-pasted stickers, usually arrow shaped to define the indicated page.

The BOOKTAG improves on the prior art by eliminating the hanging or attached devices (A) which attach to the page or book spine creating a potential for catching on fabric or clothing. The BOOKTAG also protects against the potential for damaging the book page, spine or cover by eliminating any clamps or protruding metal corners.

The BOOKTAG also improves on the prior art by eliminating adhesive striping. The pre-pasted stickers (B) are subject to loss of adhesion creating an inconvenience and the need for reserve stock. The BOOKTAG also eliminates the potential for page damage due to excessive adherence while new.

The BOOKTAG further improves on the prior art by utilizing a page indicating device which will not bend or damage the page and is constructed of a single conveniently sized sheet.

The indicator arrow, clearly apparent at a glance, while not hanging on the page points clearly to the page intended irrespective of which way it is turned or which face is viewed.

The page indication remains unchanged until the device is inverted (top to bottom). The redirected indicator then points to the appropriate page irrespective of how it is viewed or turned.

### 7. US PATENT REFERENCES

| | | | | PRIMARY |
|---|---|---|---|---|
| REFERENCE | TITLE | PUBLICATION | INVENTOR | CLASS |
| 3,143,998 | BOOK MARK | August, 1964 | Madden | 116/238 |
| 3,266,456 | BOOKMARKER | August, 1966 | O'Reilly | 116/235 |
| 4,162,659 | BOOKMARK | July, 1979 | Burke | 116/234 |
| 4,574,727 | BOOKMARK | March, 1986 | Martin, Jr. | 116/234 |
| 4,680,210 | REPOSITIONABLE DIRECTIONAL | July, 1987 | Corcoran | 283/38 |
| | MARKERS | | | |
| 5,101,756 | MARKER ARROW SYSTEM | April, 1992 | Strumbos | 116/234 |
| 5,515,809 | ADAPTABLE BOOKMARK | May, 1996 | Weinberg | 116/235 |
| 5,577,459 | PAGE AND PARAGRAPH | November | Alden | 116/234 |
| | INDICATING BOOKMARK | 1996 | | |
| 6,205,947 | PLACE FINDER BOOKMARK | March, 2001 | Drew | 116/235 |
| 7,055,861 | BOOKMARK | June, 2006 | L, Chung- | 281/42 |
| | | | yang | |

### 8. BRIEF SUMMARY OF THE INVENTION

The BOOKTAG is a simple rectangular card (bookmark shaped) that absolutely indicates the page intended irrespective of which way it is viewed or turned. Generally speaking a bookmark marks a page in the book. But in reality it marks two pages. The reader is then left to determine or remember which of the two to read next. A simple problem for which prior art has provided multiple yet often complex solutions. The BOOKTAG simply ‘points’ to the page intended.

In addition, changing the page indication is accomplished in as absolute and foolproof a fashion by inverting the device (top to bottom). The resulting change is then retained irrespective of which face is viewed or which way the device is turned.

### 9. BRIEF DESCRIPTION OF THE SEVERAL VIEWS OF THE DRAWING

FIG. 1A The obverse, face 1 of the device with perimeter segment 3 uppermost

FIG. 1B The reverse, face 2 of the device with perimeter segment 3 uppermost turned (side to side) retaining the page indication with respect to FIG. 1A; perimeter segments 4, 5 interchanging according to directional arrow

FIG. 1C The reverse, face 2 of the device with perimeter segment 6 uppermost; inverted (top to bottom) with respect to FIG. 1A, thereby indicating the opposite page; perimeter segments 4, 5 interchanging according to directional arrow

FIG. 1D The obverse, face 1 of the device with perimeter segment 6 uppermost; turned (side to side) retaining the page indication with respect to FIG. 1 C; perimeter segments 4, 5 interchanging according to directional arrow

FIG. 2A The obverse, face 1 of the device with perimeter segment 3 uppermost

FIG. 2B The reverse, face 2 of the device with perimeter segment 3 uppermost; perimeter segments 4, 5 interchanged with respect to FIG. 2A.

FIG. 2C The reverse, face 2 of the device with perimeter segment 6 uppermost; inverted (top to bottom) with respect to FIG. 2A according to directional arrow thereby altering the page indication

FIG. 2D The obverse, face 1 of the device with perimeter segment 6 uppermost; inverted (top to bottom) with respect to FIG. 2B thereby altering the page indication

FIG. 3 The device shown within book pages; both faces (1, 2) indicating the same page; perimeter segments 3, 6 remaining unchanged while perimeter segments 4, 5 interchange without affecting page indication

FIG. 4 The device shown within book pages, inverted with respect to FIG. 3 (perimeter segments 3, 6 interchanged); both faces (1, 2) indicating the alternate page; perimeter segments 4, 5 interchanging without altering page indication

FIG. 5A The device shown in perspective view with perimeter segment 3 uppermost and optional tab 9 defined by semicircular slit 7 and connecting scored line 8

FIG. 5B The device face with optional semi-circular slit 7 and connecting scored line 8

FIG. 5C The device shown in perspective view with perimeter segment 6 uppermost showing optional tab 9 defined by semicircular slit 7 and connecting scored line 8

### 10. DETAILED DESCRIPTION OF THE INVENTION

In its simplest form the BOOKTAG defines which page was intended by the reader. The device is defined by dimensions similar to a common bookmark. These dimensions can be varied based on the size of the volume in which it is utilized.

An indicator arrow is printed on each face of the device in such a way as to point to the left or right page consistently irrespective of the face that is viewed or which way it is turned.

The simplicity and utility of the device is further enhanced by the ease with which the device is reversed to indicate the opposite page. While the page indication remains unchanged irrespective of which way it is turned or viewed, the indication is reversed when the device is inverted (top to bottom).

The benefit of the BOOKTAG is in its simplicity and utility. Even without a detailed understanding of its properties the device still serves as a common bookmark. However with its full utility realized with use (and a one-line included explanation) the BOOKTAG becomes a unique and invaluable asset to readers, students and researchers alike. These attributes combine to create a broad utility for commerce as well as to industry as an advertising medium and complementary token of booksellers and publishers.

The embodiments of the invention in which an exclusive property or privilege is claimed are defined as follows:

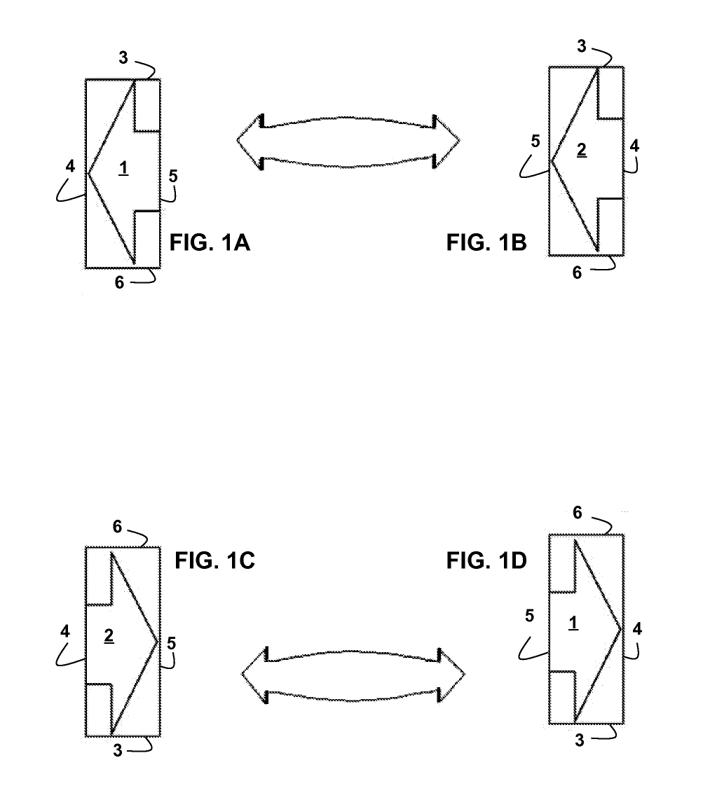

1. A rectangular card stock which indicates the page intended in a book irrespective of which face is viewed; consisting of an imprinted arrow equal to the height and width of the device on face 1 (obverse) with its point in the direction of perimeter segment 4, (FIG. 1A) and an identical imprint on face 2 (reverse) with its point in the direction of perimeter segment 5 (FIG. 1B).

2. The aspects defined in claim 1, wherein the page indicated remains unchanged (FIG. 1A, 1B; 1C, 1D) irrespective of which way the device is turned or which face, 1, 2 is viewed, i.e. turning from left to right between book pages and reversing perimeter segments 4, 5; while leaving perimeter segments 3, 6 unchanged.

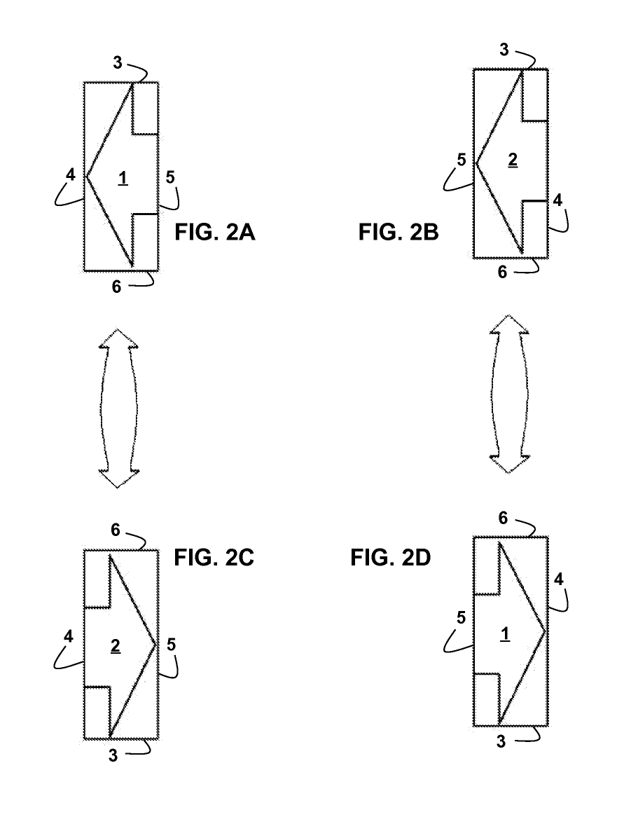

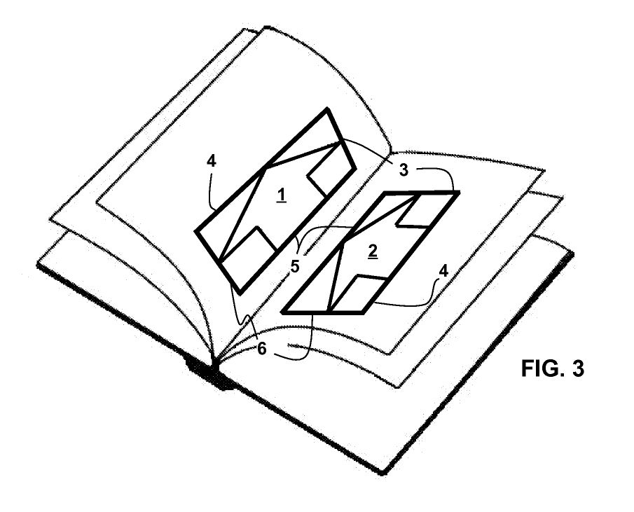

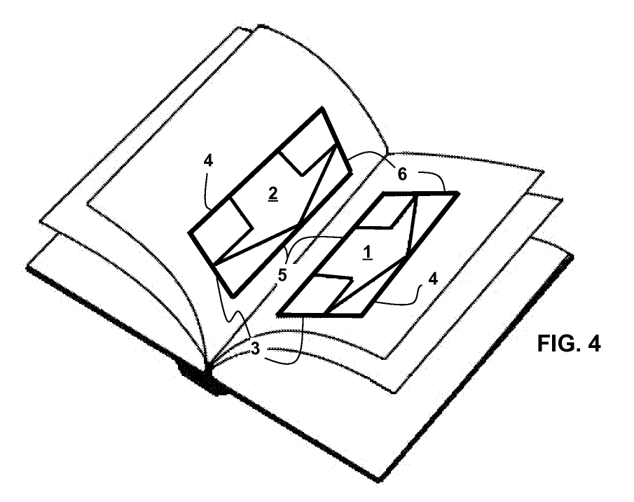

3. The aspects defined in claims 1 and 2, wherein the page indication may be reversed; consisting of an imprinted arrow (FIG. 2A, 2B) which retains the same page indication irrespective of which face is viewed 1, 2 and indicates the alternate page when inverted top to bottom (FIG. 2C, 2D); thereby reversing perimeter segments 3, 6 while leaving perimeter segments 4, 5 in the same relative position.

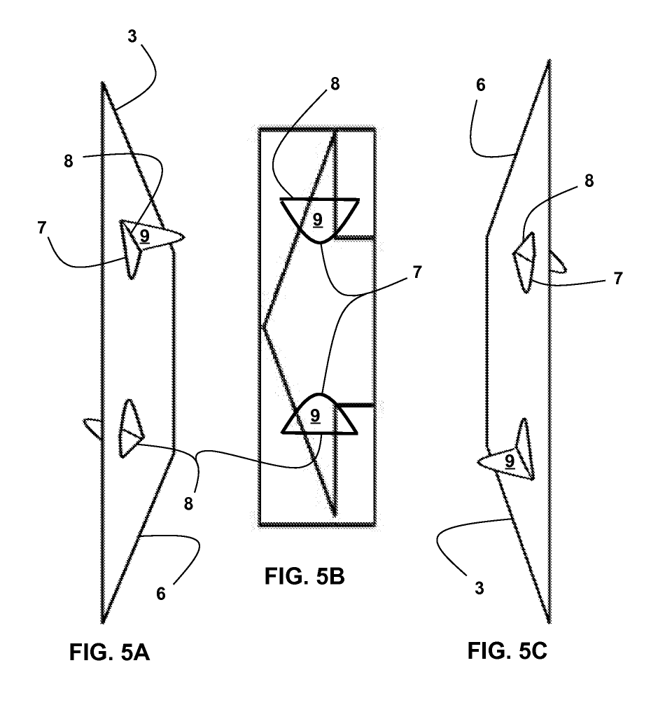

4. The aspects defined in claims 1, 2 and 3 wherein the device may be altered to hang on the page consisting of an optional tab 9 (FIG. 5A, 5B, 5C) incised in a semi-circle 7 and closed with a scored connecting line 8; allowing the tab to protrude to either face thereby functioning equally on either page and any orientation (i.e. with perimeter segment 3 or 6 at the top) and without affecting the page indication.

5. A page indicator of claims 1, 2 and 3 wherein an absolute indicator of the intended location is accomplished also is locatable while contained entirely within the volume, i.e. while not protruding from the book pages; consisting of construction utilizing card stock of weight between 60 and 110 pounds per 500 as well as both plastic and light weight metal or other supple material.

6. In conjunction with claim 4, the printing parameters define the device in terms of its layout, dimensions, appearance, utility and ease of use; as shown in FIG. 1, the preferred design consisting of a block arrow on face 1 pointing to perimeter segment 4; and on face 2 pointing to perimeter segment 5; these being also the simplest to discern at a glance; notwithstanding any other printing method designed to indicate page orientation is covered under this claim; i.e. albeit not limited to; a varied arrow design, or indicator other than an arrow; e.g. varied perimeter segment coloration, textual explanation, etc.
